(19) United States
(12) Patent Application Publication
(10) Pub. No.: US 2014/0065498 A1
(43) Pub. Date: Mar. 6, 2014

(54) Filter Module

(71) Applicants: Thomas FISCHER, Darmstadt (DE); Hannes CLASEN, Muenster (DE); Uwe FELBER, Abtsteinach (DE); Klaus LEISTER, Weinheim (DE)

(72) Inventors: Thomas FISCHER, Darmstadt (DE); Hannes CLASEN, Muenster (DE); Uwe FELBER, Abtsteinach (DE); Klaus LEISTER, Weinheim (DE)

(73) Assignee: CARL FREUDENBERG KG, Weinheim (DE)

(21) Appl. No.: 13/971,038

(22) Filed: Aug. 20, 2013

(30) Foreign Application Priority Data
Sep. 3, 2012 (DE) 102012017315.6

(51) Int. Cl. H01M 8/06

(52) U.S. Cl. CPC H01M 8/0662
USPC 429/410

(57) ABSTRACT

A filter module (1) for cleaning a fluid, including a housing (2) with an inlet opening (3) and an outlet opening (4), wherein the housing (2) forms an accommodation space (5) in which at least one filter element (6) is accommodated, wherein the filter element (6) exhibits a filter medium (7) which is configured like a block in view of the problem of configuring a filter model such that the dead space in the housing is as small as possible, that the filter module has good filter performance and a cost-effective as well as time-saving fabrication and offers effective use of a filter medium, characterized in that the filter medium (7) is pleated and is telescoped into a block (8).

### CROSS-REFERENCE TO RELATED APPLICATIONS

This application claims the benefit and priority of German Application No. 10 2012 017 315.6, filed Sep. 3, 2012. The entire disclosure of the above application is incorporated herein by reference.

### FIELD

The present disclosure relates to a filter module .

### BACKGROUND

Housings with an inlet opening and an outlet opening are known from DE 10 2009 016 739 A1, wherein the housing forms an accommodation space which contains a zigzag-like filter element. This filters particles and gases, for example from an air-supply stream for a fuel cell.

With a zigzag-like filter element, the fold walls are, in part, relatively widely spaced. In this embodiment of the filter element, it is disadvantageous that, due to the wide distance of the fold walls, a large dead space exists in the housing.

### SUMMARY

The task of the present disclosure is therefore to design a filter module such that the dead space in the housing is as small as possible. Furthermore, the filter module should have good filter performance. Further requirements that the filter module should fulfill are cost-effective and time-saving fabrication and the effective use of a filter medium.

Accordingly, the filter module is characterized in that the filter medium is pleated and telescoped into a block.

According to the present disclosure, it is recognized that a filter module with a block-like filter element produces a small dead space in the housing. This makes possible an optimal ratio of housing volume to adsorbent volume. Due to the larger adsorbent volume of the filter element, an increased adsorption capacity and better filter performance are attained. In addition, it is recognized that for the filter module according to the invention, high costs apply to cutting individual layers to size and to gluing or bonding these layers. This is to be attributed to the construction of the filter element from only one block. The combination of a block-like and pleated embodiment leads to a flexible filter element. Further, the filter element optimally fills up the housing space. It is also advantageous that pleated filter elements can be commercially procured with no problem and can be inserted with few manipulations. It is further advantageous that pleated filter elements can be inserted into the housing with the development of a clamping effect and have excellent sealing properties. As a result, the problem cited initially is solved.

The block could be disposed free of a frame element that holds the filter module. In a further embodiment, the block is configured without a gummed edge. This construction makes material-saving use possible and utilizes the construction space effectively and economically.

The filter element could exhibit a length in the 10- to 100-mm range, preferably in the range of 20 to 90 mm, especially in the 30- to 80-mm range. The typical volume flows for such filter sizes allow for optimal flow ratios.

The filter medium could exhibit a first layer, which is constructed as a carrier layer, and could exhibit a second layer, which adsorptively cleans a fluid. Adsorptive cleaning means the removal of impurities and deleterious substances by means of absorption, adsorption, physical sorption, chemisorption, and/or catalysis. The term “adsorption” is applied in the following as a term for the above-mentioned mechanisms.

A plurality of different types of layers can be used. This makes possible a multitude of uses. A first layer can be configured as a particle-filter-layer. This increases the filter efficiency, since the first layer removes particles. The second layer is to separate out from the gas undesirable chemical substances, gaseous impurities, and deleterious substances, particularly colored and odoriferous substances and those with a taste. In particular, with the second layer, gaseous impurities such as hydrocarbons, ammonia, nitrogen oxides (NOₓ gases), and sulfur-bearing components are removed. Varied functionalization for the layers allows for a multitude of uses for the filter module.

The filter medium could consist of a first layer made of a nonwoven material onto which a second layer made of adsorbent material is applied. This makes possible the cost-effective manufacture of an air-permeable layer, which exhibits a low flow resistance. In addition, nonwoven material can be commercially procured with no problem. Nonwoven material could advantageously be made of synthetic, particularly thermoplastic, fibers. The adsorbent layer removes deleterious gases. A higher deleterious-gas capacity is attained by specially aligning the filter element, whereby the service life of the filter medium can be increased. “Deleterious-gas capacity” means the ability of an adsorbent material to adsorb deleterious gases. This increases filter performance. Depending on the choice of adsorbent material, acidic and/or basic gases or hydrocarbons can be removed. This provides protection, for instance, from an early decline in fuel-cell performance, since these gases can have a deleterious effect on the fuel cells.

Activated charcoal can be used, for example, as adsorbent material. Further conceivable adsorbent materials are impregnated activated charcoals, silicon dioxide, aluminum silicate, aluminum oxide, or an ion exchanger, individually or in mixtures.

The filter medium could be configured as sintered material in one block. Sintering causes stabilization of the filter medium.

Furthermore, layers made of different filter media, such as, for example, pleated layers, flat filter-layers, and/or sintered blocks, can be combined together.

At least one flat layer could be attached to the filter medium on the outlet and/or inlet side. This flat filter-layer protects the next filter medium from larger particles directly at the stream input. In addition, flat filter-layers effectively utilize the construction space. Furthermore, the flat filter-layers at the same time have a sealing effect and avoid the formation of leakage and bypass. In one embodiment, the flat filter-layers could exhibit different porosities at the inflow and outflow sides. Advantageously, an inflow side is constructed with larger open pores, since dust particles can be removed well therewith.

According to a further embodiment, a filter layer is configured as a chemical filter, in particular as an absorption filter.

At least one filter layer could be connected in a form-fit manner to the housing. Due to the form-fit connection of the filter layer with the housing, the formation of leakage and bypass is effectively prevented. With a form-fit connection, the advantage is that no additional glue is necessary for the connection.

The uppermost filter layers facing the inlet could be configured as a coarse filter. These could be progressively constructed, whereby a smaller increase in pressure is produced due to particles being held in the coarse filter. This makes longer service life possible for the filter module. Coarse particles or small pieces are separated out in the coarse filter. The separation of smaller, finer particles or the adsorptive cleaning can occur in the next filter layers.

Salts can also be removed from the supply air by means of a suitable filter medium. These cause considerable damage to a fuel cell, for instance.

A fine filter could be attached to the coarse filter, whereby the separation of the smaller and finer particles occurs. Clogging of the filter elements and the associated increase in pressure loss are hereby reduced. In addition, the next filter layers are protected from damage due to larger particles, such as stones, for example.

The coarse filter exhibits a larger central pore-radius than the fine filter.

The lowermost filter layer facing the outlet could be configured as a protective layer. This protective layer prevents any adsorbent material coming out of the adsorptive filter from exiting the clean-air side of the filter housing.

The housing could be provided on the inlet side with a cover frame, which more securely affixes the filter element inside the housing. This makes possible the cost-effective and rapid assembly of the filter element.

The cover frame could be connected to the housing in a form-fit and/or force-fit manner. With a form-fit connection, the advantage is that no additional glue is necessary for the connection. As a result, there is no risk of the filtrate or the gas to be separated reacting with the glue. A force-fit connection affixes the frame securely onto the housing.

The cover frame could exhibit fluid inlet-openings. These fluid inlet-openings make the problem-free entry of air possible.

The housing could exhibit ribs, in which one end of the ribs opens into the housing and the other end of the ribs is loose. The ribs can be constructed as thin plates, in which they exhibit different lengths. By means of a slanting arrangement of the ribs relative to the housing wall, the distance of the ribs to one another is reduced at the open ends of the ribs. Advantageously, these ribs make the homogeneous flow through the filter element possible. This leads to optimal flow ratios and additionally improves filter performance. Moreover, the ribs support the filter element.

Depending on the choice of process parameters, a low pressure can be produced in the accommodation space, namely in the flow space, whereby the flow through the filter medium is homogeneous.

The filter module could be used in a fuel cell. Due to its increased adsorption capacity and service life, the filter module is outstandingly suited as a filter module for a fuel cell.

A fuel cell could include a filter module of the type previously described. Due to its increased filter performance, the filter module is outstandingly suited as a filter module for a fuel cell.

### DRAWINGS

The drawings show

FIG. 1 is a schematic cross-sectional view of a filter module with a pleated filter element, which is clamped in the housing as a block,

FIG. 2 is a perspective view of the housing of the filter module according to FIG. 1,

FIG. 3 is a further perspective view of the housing of the filter module according to FIG. 1, with interior structures represented by dashed lines,

FIG. 4 is a plan view of the accommodation space of the filter module according to FIG. 1, and

FIG. 5 is a plan view of the accommodation space of the filter module according to FIG. 1, in which structures that are covered by the cover frame are represented by dashed lines.

### DETAILED DESCRIPTION

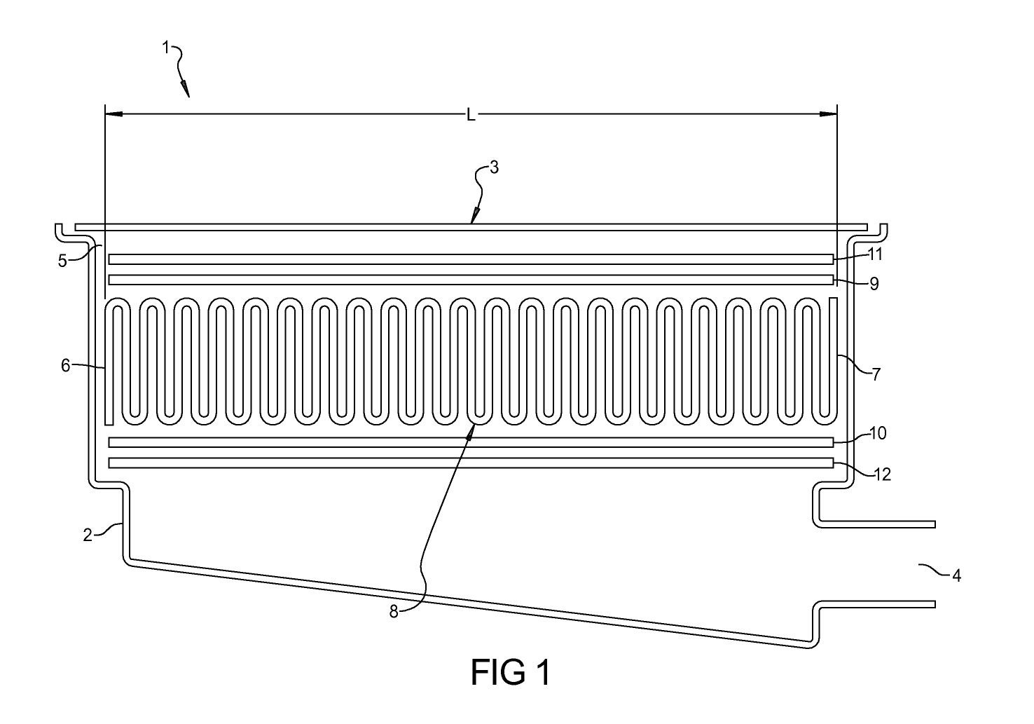

FIG. 1 shows a filter module 1 for cleaning a fluid, including a housing 2 with an inlet opening 3 and an outlet opening 4, in which the housing 2 forms an accommodation space 5 in which at least one filter element 6 is accommodated. The filter element 6 exhibits a filter medium 7, which is configured like a block. The filter medium 7 is pleated and telescoped together into a block 8.

The filter element 6 exhibits a length L in the range of 10 to 100 mm. In this actual case, the length L of the filter element 6 is 90 mm.

The block 8 is disposed free of a frame element that affixes the filter module 1.

The filter medium 7 exhibits a first layer, which is constructed as a carrier layer, and it exhibits a second layer that cleans a fluid adsorptively.

The filter medium 7 consists of a first layer made of thin nonwoven material, onto which a second layer made of adsorbent material is applied.

An upper, flat filter-layer 9 is attached to the filter medium 7 on the inlet side and a lower, flat filter-layer 10 on the outlet side.

The lower, flat filter-layer 10 is configured as a particle filter.

An uppermost filter layer 11 facing the inlet 3 is configured as a coarse filter.

A fine filter, not depicted, is attached to the coarse filter.

A lowermost filter layer 12 facing the outlet 4 is configured as a protective layer.

An adsorptive filter-layer, not depicted, is disposed in front of the lowermost filter layer 12.

At least one uppermost filter layer 11 is connected to the housing 2 in a form-fit manner.

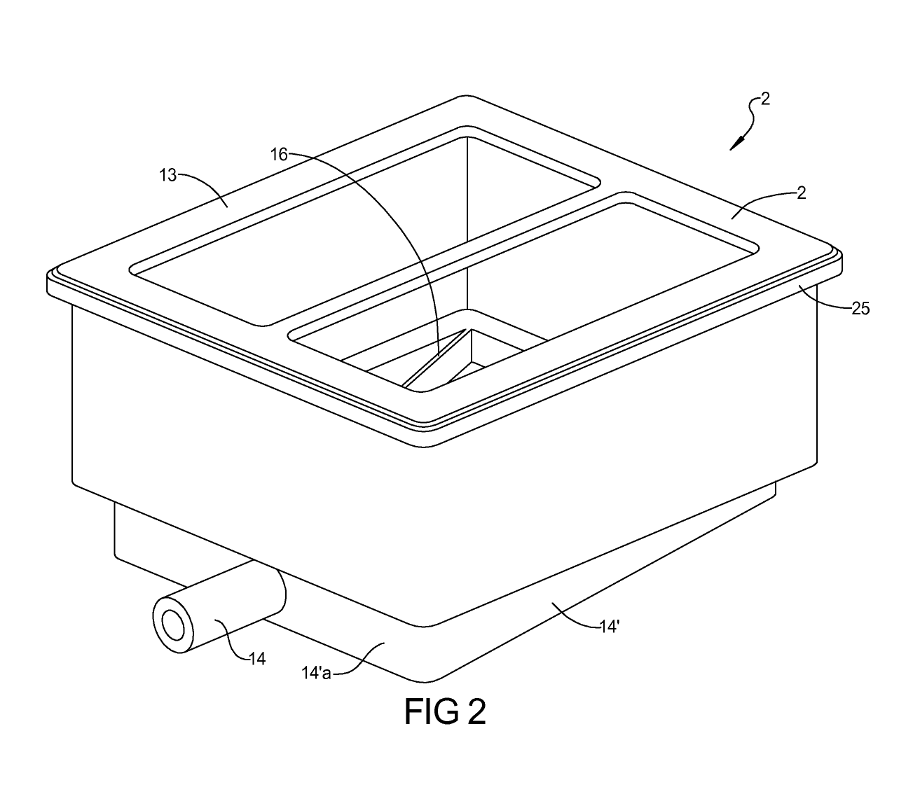

FIG. 2 shows a housing 2. This housing 2 is provided on the inlet side with a cover frame 13, which more securely affixes the at least one filter element 6 inside the housing 2.

The cover frame 13 is connected to the housing 2 in a form-fit manner and the cover frame 13 exhibits a projecting flange edge 25.

The housing 2 is configured in an essentially square shape.

In addition, the housing 2 includes a flow space 14′. On the housing 2 is constructed a flow feedpipe 14 at the front side 14′a of the flow space 14′. The flow feedpipe 14 projects out from the flow space 14′.

The flow space 14′ narrows away from the flow direction of the fluid.

The flow space 14′ exhibits ribs 16.

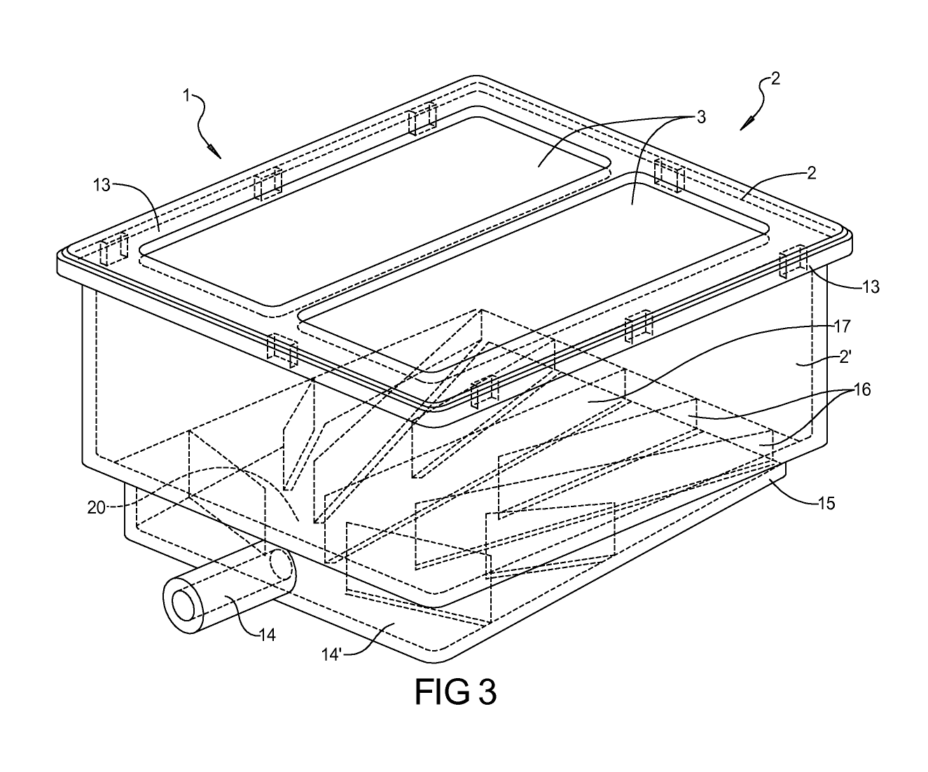

FIG. 3 shows a housing 2 of the filter module 1. This housing 2 is provided with a cover frame 13 on the inlet side.

The housing 2 includes a flow space 14′. A flow feedpipe 14 is constructed on the housing 2 at the front side 14′a of the flow space 14′.

The flow feedpipe 14 projects out from the flow space 14′.

The housing 2 exhibits ribs 16 in the flow space 14′, in which one end of the ribs 16 opens into the housing 2 and the other end of the ribs 16 is loose. These ribs 16 are of different lengths. With the exception of a center rib 17, the other ribs 16 are disposed obliquely inward relative to a housing wall 15, offset from one of the walls 2′. They continue toward the center rib 17. These ribs are disposed on the floor 20 of the flow space 14′.

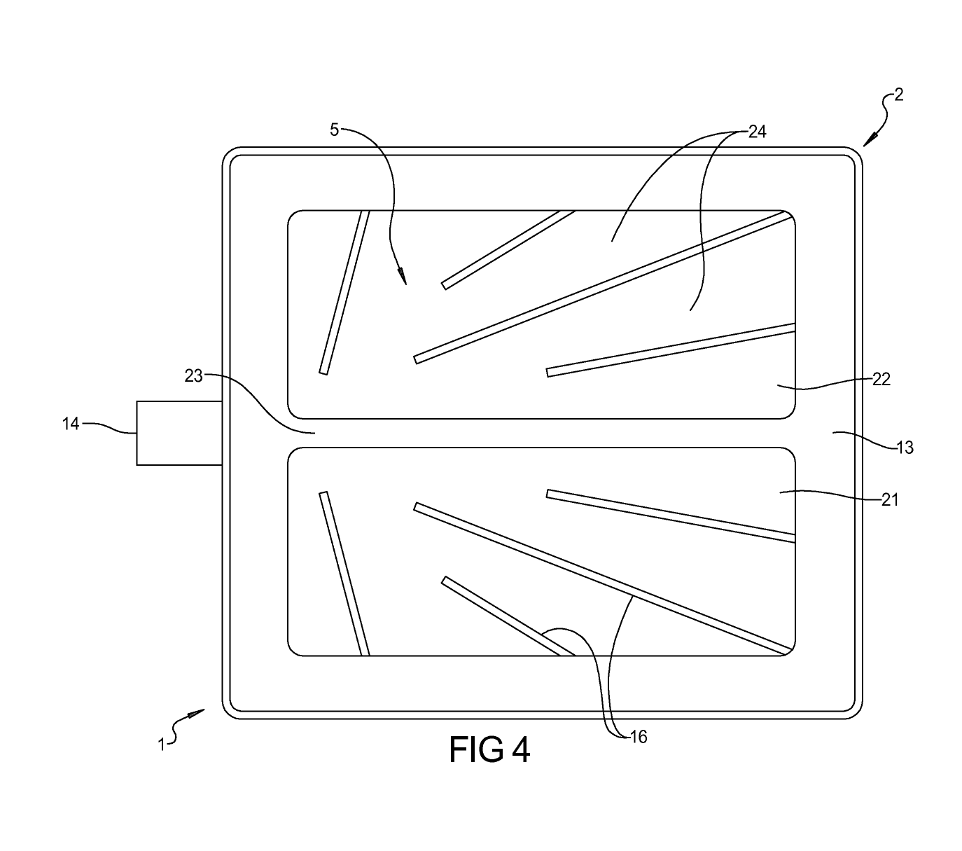

FIG. 4 shows a plan view of the filter housing 2 and the accommodation space 5 of the filter module 1. A flow feedpipe 14′ is disposed on the housing 2 at the front side of the housing 2.

The cover frame 13 exhibits fluid inlet-openings 21, 22. These fluid inlet-openings 21, 22 are configured in a square shape.

The housing 2 exhibits ribs 16, in which one end of the ribs is loose. These ribs 16 are of different lengths and continue to a center leg 23 of the cover frame 13.

The arrangement of the ribs 16 divides the flow space 14′ into individual flow fields 24.

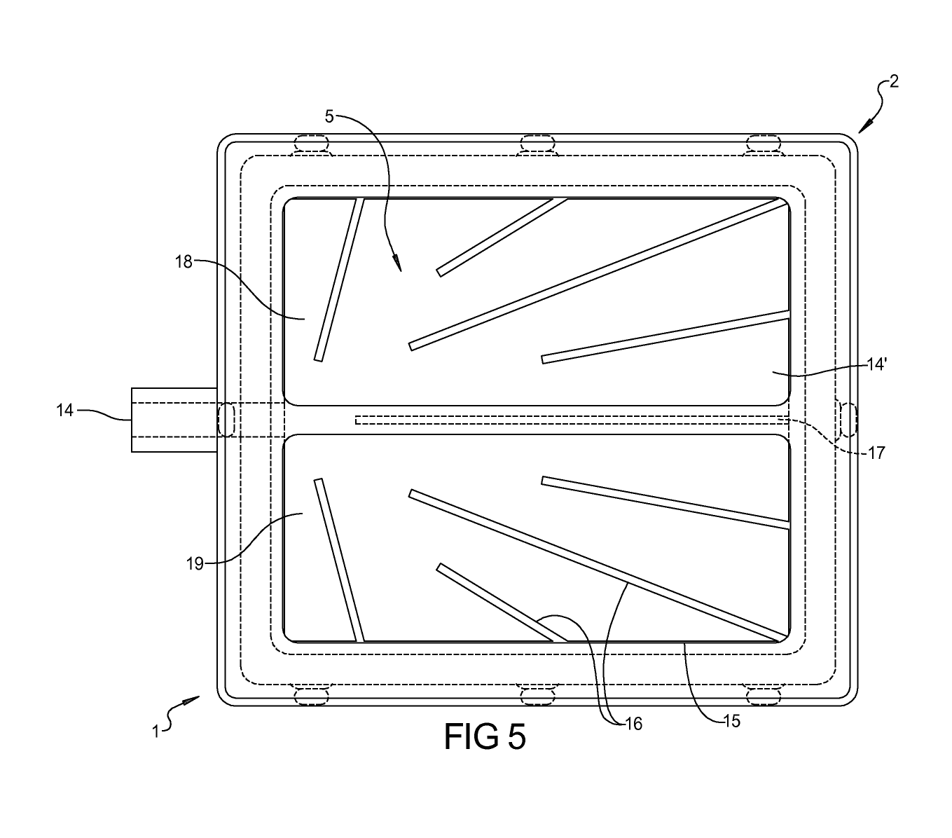

FIG. 5 shows a plan view of the housing 2 and the accommodation space 5 of the filter module 1.

A flow feedpipe 14 is constructed on the housing 2 at the front side 14′a of the flow space 14′.

This housing exhibits ribs 16, wherein one end of the ribs 16 opens into the housing 2 and the other end of the ribs 16 is loose. These ribs 16 are of different lengths. With the exception of a center rib 17, the other ribs 16 are disposed obliquely relative to the housing wall 15. They continue toward the center rib 17. The center rib 17, due to its arrangement in the housing 2, partially divides the flow space 14′ into two areas 18 and 19.

1. A filter module (1) for cleaning a fluid, comprising a housing (2) having an inlet opening (3) and an outlet opening (4), wherein the housing (2) forms an accommodating space (5) in which at least one filter element (6) is accommodated, wherein the filter element (6) has a filter medium (7) which is configured in a block-like manner, wherein the filter medium (7) is pleated and pushed together to form a block (8).

2. The filter module (1) according to claim 1, wherein the block (8) is arranged in a manner free from a frame element which fixes the filter module.

3. The filter module (1) according to claim 1, wherein the filter element (6) has a length (L) in the range of 10 to 100 mm.

4. Filter module (1) according to claim 1, wherein the filter medium (7) has a first layer, which is in the form of a carrier layer, and a second layer, which cleans a fluid in an adsorptive manner.

5. The filter module (1) according to claim 4, wherein the filter medium (7) includes a first layer made of nonwoven material, to which a second layer made of adsorbent material is applied.

6. The filter module (1) according to claim 1, wherein the filter medium (7) is configured as a material sintered to form a block (8).

7. The filter module (1) according to claim 1, wherein at least one planar filter layer (9, 10, 11, 12) adjoin(s) the filter medium (7) on the inlet side and/or outlet side.

8. The filter module (1) according to claim 7, wherein at least one filter layer (11) is connected to the housing (2) in a form-fitting manner.

9. The filter module (1) according to claim 7, wherein the top filter layer (11) facing the inlet (3) is configured as a coarse filter.

10. The filter module (1) according to claim 9, wherein a fine filter follows the coarse filter.

11. The filter module (1) according to claim 7, wherein the bottom filter layer (12) facing the outlet (4) is configured as a protective layer.

12. The filter module (1) according to claim 1, wherein the housing (2) is provided on the inlet side with a covering frame (13) which captively fixes the filter element (6) inside the housing (2).

13. The filter module (1) according to claim 12, wherein the covering frame (13) is connected to the housing (2) in a form-fitting or materially integral manner.

14. The filter module (1) according to claim 1, wherein the covering frame (13) has fluid inlet openings (21, 22).

15. The filter module (1) according to claim 1, wherein the housing (2) has ribs (16, 17), wherein one end of the ribs (16, 17) leads into the housing (2) and the other end of the ribs (16, 17) is exposed.
